(19) United States
(12) Patent Application Publication
(10) Pub. No.: US 2014/0322588 A1
(43) Pub. Date: Oct. 30, 2014

(54) HOUSING FOR A BATTERY CELL, COMPRISING A PAINT COATING FOR ELECTRICAL INSULATION, BATTERY CELL, BATTERY, AND MOTOR VEHICLE

(71) Applicants: Robert Bosch GmbH, Stuttgart (DE); Samsung SDI Co., Ltd., Yongin-si, Gyeonggi-do (KR)

(72) Inventor: Wolfgang Duernegger, Schorndorf (DE)

(73) Assignee: Robert Bosch GmbH, Stuttgart (DE)

(21) Appl. No.: 14/364,088

(22) PCT Filed: Nov. 15, 2012
(86) PCT No.: PCT/EP2012/072767

§ 371 Date: Jun. 10, 2014

(30) Foreign Application Priority Data
Dec. 15, 2011 (DE) 10 2011 088 739.3

(51) Int. Cl. H01M 2/02

(52) U.S. Cl. CPC H01M 2/0262; H01M 2220/20
USPC 429/149; 429/176; 523/134

(57) ABSTRACT

A housing for a battery cell includes a paint coating for electrical insulation. The paint coating contains adhesive-containing particles, the adhesive of which can be activated under defined conditions. For example, the adhesive can be activated by pressure when clamping battery cells comprising such a housing, such that the friction coefficient of the contact surfaces of the housing is increased.

The present invention relates to a housing for a battery cell, comprising a varnish coating for electrical insulation, a battery cell, a battery and a motor vehicle.

### PRIOR ART

In vehicles with at least partial electric drive, electrical storage devices are used in order to store the electrical energy for the electric motor, which assists the drive or acts as the drive. So-called lithium-ion batteries find an application here in vehicles of the latest generation. These batteries are characterized by, among other things, high energy densities and an extremely low self-discharge. Lithium-ion battery cells have at least one positive and one negative electrode (cathode or anode), which possess the ability reversibly to store lithium ions (Li⁺) (intercalation) or to release them again (deintercalation).

FIG. 1 illustrates how individual battery cells 10 can be combined to produce battery modules 12 and then batteries 14. This takes place through the connection of the poles in parallel or in series (not illustrated here). By definition, a battery module 12 or a battery 14 in this case consists of at least two battery cells 10.

FIG. 2 illustrates various types of housing and packaging for lithium-ion cells, in this case being, for example, a cylindrical hard-case cell 40, a so-called pouch cell 50 (softpack) and a prismatic hard case cell 60. The two embodiments with hard-case housings in this case respectively exhibit a metallic main body, which, for the purposes of insulation, is covered with a film, a varnish or the like made of an electrically non-conducting material. Purely metallic battery cell housings for lithium-ion cells, in which a potential is applied to the housing, must, therefore, be electrically insulated externally if they are assembled to produce high-voltage batteries. In particular special insulating varnishes are used for the electrical insulation of the cells.

According to the prior art, lithium-ion battery cells in particular are clamped securely to one another, so that any expansion during operation due to the intercalation and deintercalation of the ions is largely prevented. Clamping also ensures, in addition, that the interconnected battery cells are in contact with a component for temperature control and are in positive engagement during normal use of the product and in the event of a crash.

In order to ensure the functional performance of the described clamping, the surfaces of the cells lying in positive engagement must exhibit high friction values, depending on the construction of the lithium-ion battery, the value of which depends on the design of the lithium-ion battery.

In the event of excessively low frictional values between the cell surfaces lying in positive engagement, relative movements can occur between the cells, which can give rise to damage to the lithium-ion battery.

The use of a friction-increasing coating, for example a molybdenum coating, in order to obtain a stable connection of component parts is already known from DE 10 2010 009 901 A1.

### DISCLOSURE OF THE INVENTION

According to the invention, a housing for a battery cell, preferably a lithium-ion battery cell, is made available which is provided with a varnish coating for electrical insulation, the varnish coating containing adhesive-containing particles, the adhesive of which can be activated under defined conditions.

As described previously, battery cells, in particular lithium-ion battery cells, are clamped together, the surfaces of the housings of the battery cells lying in positive engagement being required to exhibit defined friction values in order to ensure the stability of the batteries.

It is possible to increase the coefficients of friction of the housings of the battery cells specifically during assembly by bursting of the adhesive-containing particles of the varnish coating, which release adhesive under defined conditions, preferably with initiation by pressure or force, initiation by temperature, initiation by radiation or by chemical motivation, and particularly preferably with initiation by pressure or force. The adhesive reaches the surface of the varnish coating in this way.

The arrangement of the individual housings in relation to one another can thus be effected advantageously and without problems, and the possibility of an increase in the coefficient of friction by the activated adhesive only arises when the battery cells are clamped.

Also, only the adhesive-containing particles of the functional surfaces necessary for clamping are activated advantageously in connection with this, so that the clamped battery possesses a lower coefficient of friction on its outer surfaces, that is to say the coefficient of friction is only influenced on surfaces which lie in positive engagement. As a result, the handling or the production sequence of a corresponding battery is significantly facilitated.

Provision for the activation of the adhesive can also be made by contact of the battery with a cooling element, for example, on which the battery is conventionally arranged, since reliable contact for reliable temperature control of the battery is necessary in this case, too.

Materials for producing appropriate particles are already familiar from the prior art to a person skilled in the art, which materials can preferably be constituted by adhesive itself. For this purpose, for example, the outer layer of the adhesive can be hardened in order to form the particle. Activation causes this layer to burst, with the result that the adhesive contained therein is able to emerge and in so doing to become active.

The adhesive-containing particles can differ in their nature in other respects, there being a preference for an embodiment as a hollow body filled with adhesive.

It is also possible for the particles to possess a porous structure, in which the adhesive is present, the adhesive being able to emerge from or being forced from this structure by the activation.

Suitable adhesives from the field of physically bonding adhesives, chemically curing adhesives or adhesives without strengthening mechanisms are generally familiar to a person skilled in the art, which adhesives are selected depending on the requirements.

The use of 2-component adhesives is also possible, in which case only two different particles need to be integrated into the varnish coating for this purpose.

The desired chemical reaction to form the adhesive takes place upon release of the components, for example by pressure.

The size of the particles can fundamentally be selected freely as required and can lie on the macroscopic, microscopic or nanoscopic scale.

The desired coefficient of friction can be adjusted selectively by the size of the particles and the quantity used in relation to the surface area, as well as by the appropriate choice of adhesive.

Selective adaptation of the coefficient of friction can also be achieved by causing the number of burst adhesive-containing particles to be dependent on the initial surface pressure on the surfaces lying in the force flux, which means that a lower coefficient of friction is obtained for a lower initial surface pressure, and a higher coefficient of friction is obtained for a higher initial surface pressure. This behavior is possible through an appropriate choice of particles and the adhesive that is used, or by the use of particles of different sizes.

The choice of the varnish systems that are used for insulation purposes can be made advantageously primarily according to the insulation properties through the arrangement according to the invention of housings for battery cells.

According to a particularly preferred embodiment of the invention, the varnish coating exhibits two layers. A basic insulation is thus provided, which does not exhibit any particles and assures optimal insulation. This in turn can consist of a single layer or can exhibit a plurality of layers. Present on top of this is at least one second varnish layer, which contains the particles.

Both layers can consist of the same varnish. It is also possible, however, to specify different varnishes.

This preferred construction of the varnish coating permits an adaptation of the coefficient of friction to be undertaken advantageously without changing the properties of the basic insulation system.

Varnish systems with individually adaptable coefficients of friction, which increase the product reliability and exclude any risk as described by way of introduction, are thus available.

With reference to the above analysis, it is possible to make use of mixtures of particles which vary with regard to their geometry and size, mixtures of particles made of various materials, mixtures of particles with a varied structure, for example hollow bodies and porous bodies, mixtures of particles with different mechanical, electrical, chemical and thermal properties and combinations thereof.

The object of the present invention also includes a battery cell, which is arranged inside a housing according to the invention and is preferably a lithium-ion cell, a battery, which exhibits at least two of these battery cells, and a motor vehicle having an electric drive motor for driving the motor vehicle and a battery connected or connectable to the electric drive motor.

Advantageous further developments of the invention are indicated in the dependent claims and are described in the description.

### DRAWINGS

Illustrative embodiments of the invention are explained in more detail on the basis of the drawings and the following description. In the drawings,

FIG. 1 depicts a battery cell, a module and a battery;

FIG. 2 depicts various casings and types of packaging for lithium-ion cells;

FIG. 3 depicts a detailed view of a housing according to the invention for a battery cell with non-activated, adhesive-containing particles, and

FIG. 4 depicts a detailed view of housings according to the invention for battery cells with activated adhesive-containing particles.

### EMBODIMENTS OF THE INVENTION

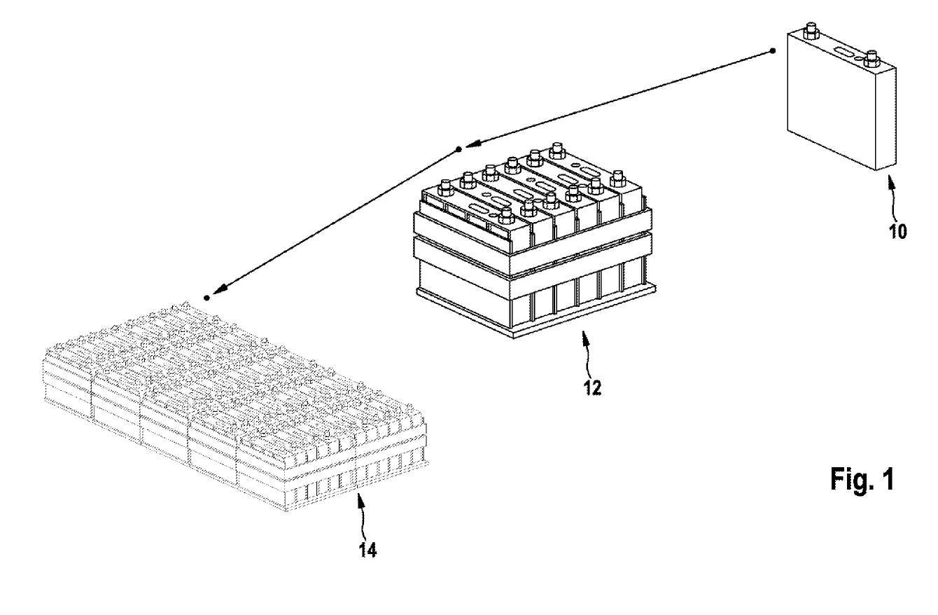

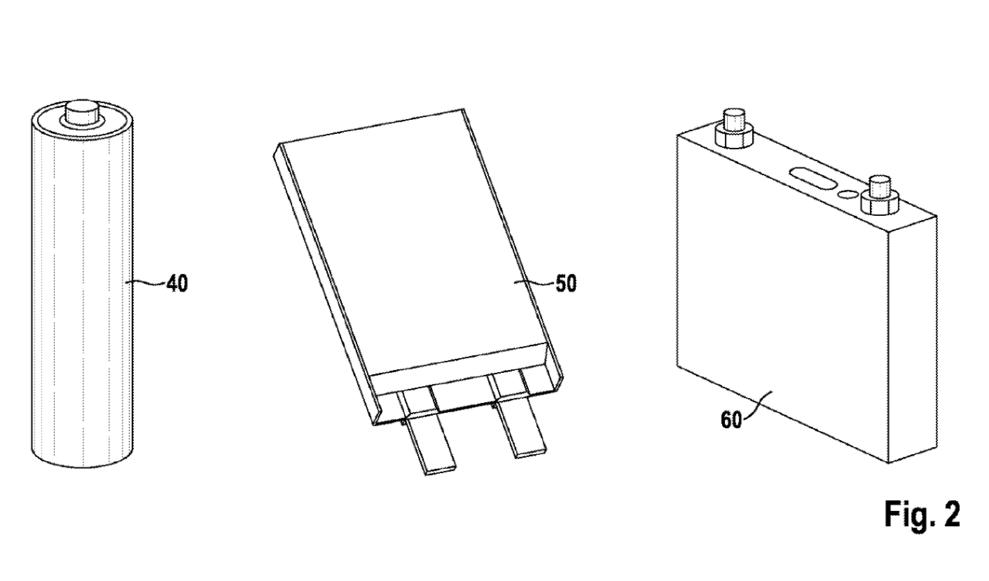

An explanation of the prior art has already been provided in FIGS. 1 and 2.

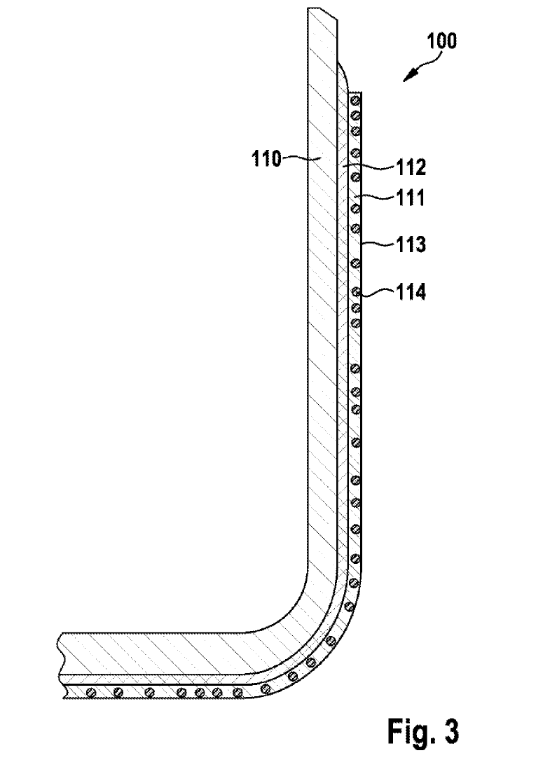

FIG. 3 depicts a detail of a housing 100 for a battery cell. A varnish coating 111 for electrical insulation is present on the outside of the wall 110 of the housing 100. The varnish coating 111 consists of at least two layers, there being provided directly on the wall 110 a basic insulation 112, which is provided with an external varnish layer 113. Distributed in the outer varnish layer 113 are adhesive-containing particles 114, of which the adhesive is capable of being activated or released through defined conditions.

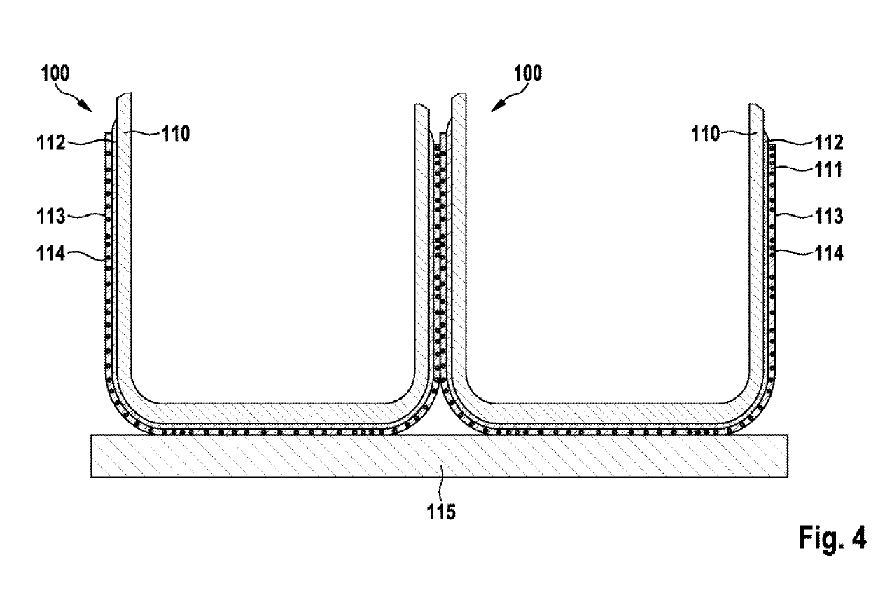

Depicted in FIG. 4 are housings 100 according to the invention, of which the surfaces that are in contact with one another are bonded to one another by activation of the adhesive-containing particles 114. The reference designations correspond to those used in FIG. 3. The two housings 100 are in addition arranged on a cooling plate 115 for temperature control, the surfaces that are in contact with one another, in this case, too, being bonded to one another by activation of the adhesive-containing particles 114.

1. A housing for a battery cell, the housing comprising:
a varnish coating for electrical insulation, the varnish coating containing adhesive-containing particles,
wherein the adhesive of the adhesive-containing particles is configured to be activated under defined conditions.

2. The housing as claimed in claim 1, wherein activation of the adhesive is configured to be one of initiated by pressure, initiated by temperature, initiated by radiation, and chemically motivated.

3. The housing as claimed in claim 1, wherein the adhesive-containing particles are one of hollow bodies filled with the adhesive and having a porous structure, inside which the adhesive is present.

4. The housing as claimed in claim 1, wherein the adhesive-containing particles are present in at least two different sizes.

5. The housing as claimed in claim 1, wherein:
the varnish coating is configured to exhibit a basic insulation arranged directly on the housing and at least one layer of varnish present on the basic insulation, and
the at least one layer of varnish is provided with the adhesive-containing particles.

6. A battery cell, comprising:
a housing including a varnish coating for electrical insulation, the varnish coating containing adhesive-containing particles,
wherein the adhesive of the adhesive-containing particles is configured to be activated under defined conditions.

7. The battery cell as claimed in claim 6, wherein the battery cell is a lithium-ion cell.

8. A battery, comprising:
at least two battery cells, at least one of the at least two battery cells including a housing, the housing including a varnish coating for electrical insulation, the varnish coating containing adhesive-containing particles,
wherein the adhesive of the adhesive-containing particles is configured to be activated under defined conditions.

9. The battery as claimed in claim 8, wherein:
the battery is configured to be included in a motor vehicle having an electric drive motor configured to drive the motor vehicle, and
the battery is configured to be connected to the electric drive motor.
